(19) United States
(12) Patent Application Publication
(10) Pub. No.: US 2017/0139567 A1
(43) Pub. Date: May 18, 2017

(54) Entering Unlock Sequences Using Head Movements

(71) Applicant: Google Inc., Mountain View, CA (US)

(72) Inventor: Chun Yat Frank Li, Mountain View, CA (US)

(21) Appl. No.: 13/935,125

(22) Filed: Jul. 3, 2013

(51) Int. Cl. G06F 3/0487

(52) U.S. Cl. CPC G06F 3/0487

(57) ABSTRACT

Embodiments described herein may help to provide a lock-screen for a computing device. An example method involves: (a) displaying two or more rows of characters and an input region that is moveable over the rows of characters, (b) based on head-movement data, determining movement of the input region with respect to the rows of characters, (c) determining an input sequence, where the sequence includes one character from each of the rows of characters that is selected based at least in part on the one or more movements of the input region with respect to the rows of characters, (d) determining whether or not the input sequence matches a predetermined unlock sequence, and (e) if the input sequence matches the predetermined unlock sequence, then unlocking the computing device.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a graphic display close enough to a wearer's (or user's) eye(s) such that the displayed image appears as a normal-sized image, such as might be displayed on a traditional image display device. The relevant technology may be referred to as “near-eye displays.”

Wearable computing devices with near-eye displays may also be referred to as “head-mountable displays” (HMDs), “head-mounted displays,” “head-mounted devices,” or “head-mountable devices.” A head-mountable display places a graphic display or displays close to one or both eyes of a wearer. To generate the images on a display, a computer processing system may be used. Such displays may occupy a wearer's entire field of view, or only occupy part of wearer's field of view. Further, head-mounted displays may vary in size, taking a smaller form such as a glasses-style display or a larger form such as a helmet, for example.

Emerging and anticipated uses of wearable displays include applications in which users interact in real time with an augmented or virtual reality. Such applications can be mission-critical or safety-critical, such as in a public safety or aviation setting. The applications can also be recreational, such as interactive gaming. Many other applications are also possible.

### SUMMARY

Example embodiments help to provide interfaces for unlocking a computing device, such as a head-mountable device (HMD). In particular, an HMD may display two or more rows of characters. A user may then use head movements to enter an unlock sequence that may consist of one character selected from each of the rows of characters. The selected sequence of characters may be compared to a predetermined unlock sequence in order to determine whether to unlock the device.

In one aspect, a computer-implemented method may involve: (a) while a computing device is locked, causing a display of the computing device to display two or more rows of characters and an input region that is moveable over the rows of characters; (b) based at least in part on head-movement data that is indicative of head movement, determining one or more movements of the input region with respect to the rows of characters; (c) determining an input sequence that comprises a sequence of characters, where the sequence comprises one character from each of the two or more rows of characters that is selected based at least in part on the one or more movements of the input region with respect to the rows of characters; (d) determining whether or not the input sequence matches a predetermined unlock sequence, where the predetermined unlock sequence comprises a predetermined sequence of two or more characters; and (e) based on the determination as to whether or not the input sequence matches the predetermined unlock sequence, determining whether or not to unlock the computing device.

In another aspect, a non-transitory computer readable medium has stored therein instructions executable by a computing device to cause the computing device to perform functions comprising: (a) while the computing device is locked, displaying two or more rows of characters and an input region that is moveable over the rows of characters; (b) receiving head-movement data that is indicative of head movement; (c) based at least in part on head-movement data, determining one or more movements of the input region with respect to the rows of characters; (d) determining an input sequence that comprises a sequence of characters, where the sequence comprises one character from each of the two or more rows of characters that is selected based at least in part on the one or more movements of the input region with respect to the rows of characters; (e) determining whether or not the input sequence matches a predetermined unlock sequence, where the predetermined unlock sequence comprises a predetermined sequence of two or more characters; (f) if the input sequence matches the predetermined unlock sequence, causing the computing device to unlock; and (g) if the input sequence does not match the predetermined unlock sequence, refraining from unlocking the computing device.

In a further aspect, a computing device may include a display interface to a display, a non-transitory computer readable medium, and program instructions stored on the non-transitory computer readable medium and executable by at least one processor to: (a) while the computing device is locked, cause the display to display two or more rows of characters and an input region that is moveable over the rows of characters; (b) receive head-movement data that is indicative of head movement; (c) based at least in part on head-movement data, determine one or more movements of the input region with respect to the rows of characters; (d) determine an input sequence that comprises a sequence of characters, where the sequence comprises one character from each of the two or more rows of characters that is selected based at least in part on the one or more movements of the input region with respect to the rows of characters; (e) determine whether or not the input sequence matches a predetermined unlock sequence, where the predetermined unlock sequence comprises a predetermined sequence of two or more characters; and (f) based on the determination as to whether or not the input sequence matches the predetermined unlock sequence, determine whether or not to unlock the computing device.

In yet another aspect, example embodiments may provide for: (a) while a computing device is locked, means for causing a display of the computing device to display two or more rows of characters and an input region that is moveable over the rows of characters; (b) based at least in part on head-movement data that is indicative of head movement, means for determining one or more movements of the input region with respect to the rows of characters; (c) means for determining an input sequence that comprises a sequence of characters, where the sequence comprises one character from each of the two or more rows of characters that is selected based at least in part on the one or more movements of the input region with respect to the rows of characters; (d) means for determining whether or not the input sequence matches a predetermined unlock sequence, where the predetermined unlock sequence comprises a predetermined sequence of two or more characters; and (e) based on the determination as to whether or not the input sequence matches the predetermined unlock sequence, means for determining whether or not to unlock the computing device.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1A illustrates a wearable computing system according to an example embodiment.

FIG. 1B illustrates an alternate view of the wearable computing device illustrated in FIG. 1A.

FIG. 1C illustrates another wearable computing system according to an example embodiment.

FIG. 1D illustrates another wearable computing system according to an example embodiment.

FIGS. 1E to 1G are simplified illustrations of the wearable computing system shown in FIG. 1D, being worn by a wearer.

FIG. 2A is a simplified block diagram of a computing device according to an example embodiment.

FIG. 2B shows a projection of an image by a head-mountable device, according to an example embodiment.

FIG. 3 is a flow chart illustrating a method, according to an example embodiment.

FIGS. 4A to 4D illustrate a sequence of screenshots of a display, as a user enters an unlock sequence, according to an example embodiment.

FIGS. 5A to 5D illustrate a sequence of user head movements corresponding to the screenshots of FIGS. 4A to 4D, according to an example embodiment.

FIGS. 6A to 6D illustrate an alternative sequence of screenshots of a display, as a user enters an unlock sequence, according to an example embodiment.

### DETAILED DESCRIPTION

Example methods and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. In the following detailed description, reference is made to the accompanying figures, which form a part thereof. In the figures, similar symbols typically identify similar components, unless context dictates otherwise. Other embodiments may be utilized, and other changes may be made, without departing from the spirit or scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

### I. Overview

Computing devices such as smartphones often employ a security lock screen to protect the user's personal data. The user may be prompted to enter a PIN number, often a four-digit number, which must match a predetermined PIN to unlock the device. With some devices such as smartphones, the input space and output space coincide so that the user can easily select numbers to enter a PIN on the device. However, traditional lock screens do not work well with HMD's (head-mounted displays) because the user cannot easily map a touchpad on the device to select PIN numbers.

Example embodiments help to provide interfaces for unlocking a computing device, such as a head-mountable device (HMD). For example, user head movements may be used to enter a PIN to unlock a computing device. In one example embodiment, the device may be woken up when the user tilts his head upward past a certain angle. One row of numbers may be displayed for each number in the PIN (e.g., four rows of numbers for a 4-digit PIN), along with a cursor. The user may then navigate the cursor through the rows of numbers using head movements. For example, the user may be able to navigate the cursor down through the rows by tilting his head downward. Additionally, the user may be able to navigate the cursor through the numbers in a row by tilting his head to the left or right.

In some embodiments, a number may be selected from a row for the PIN based on where the cursor is in a row when the user moves the cursor past the bottom of the row. For example, a number may be selected when the cursor is moved horizontally to the number and then moved downward across the bottom of the number. Additionally, the display may contain a graphical indication to indicate to the user which numbers have been selected for the PIN, as the user is entering the PIN. For example, numbers may be bolded and/or underlined after they are selected.

Additionally, the user may be able to unselect a number if an error is made. For example, the user may be able to unselect a number by tilting his head upward back through the row of numbers. A number may be unselected when the cursor crosses back through the top of the row of numbers containing the previously selected number as the user tilts his head back upward. Alternative methods of unselecting a number may also be used. For example, the user may be able to unselect one or more previously selected numbers by giving a specific voice command.

In some embodiments, movement of the cursor with respect to the rows of numbers may be presented to a user by moving the rows of numbers in the display, while keeping the cursor at the same location in the display (e.g., in the center of the display). For instance, an HMD's display may effectively function as a viewing window to a portion of the rows of numbers, and the HMD may move the viewing window based on the head movement.

In an example embodiment, the rows of numbers may all contain the same set of numbers. Alternatively, each row may contain a subset of a certain set of numbers. In a further embodiment, the numbers may be displayed in sequential order, or they may be displayed in a different order such as a random order.

In an additional embodiment, the user may be able to input a particular sequence of numbers by making one or more gestures after the cursor has been moved over each number. For instance, the user could select a number by making certain eye gestures (e.g., winking, blinking, etc.), making certain hand gestures (e.g. waving a hand, snapping fingers, etc.), giving certain voice commands, and/or entering an input on a mechanical interface (e.g., tapping a touchpad, pushing a button, etc.). Thus, to select a particular number from the rows of numbers, the user can move his head until the cursor is over the particular number, and then make a gesture to select the number. The user can repeat this process using head movements and making gestures to input the entire sequence of numbers.

In an example embodiment, it may be determined that the user has completed an unlock sequence when the user's head is level again. If the entered PIN matches the predetermined PIN, the device will unlock. If the PIN does not match, an error message may be displayed so that the user must repeat the process. Alternately, the user may be able to use the process described above to unselect previously selected numbers in order to navigate back up to correct the PIN. In alternative embodiments, the user may indicate that the unlock sequence is complete by tapping the touchpad on the HMD or giving a specific voice command to the HMD.

Other configurations are also possible. For example, the user may be able to wake up the device by looking down. The user may then be able to select a PIN by navigating upward through the rows of numbers. Alternately, the user may be able to wake up device by looking to the left. The user may then be able to select a PIN by navigating rightward through columns of numbers. In another example, the rows may be displayed as curved arcs rather than straight lines. In this example, head movements in a direction along one of the arcs may determine the location of the curser within a row. Furthermore, head movements in a direction across the arcs may determine which row contains the cursor.

In an alternative implementation, the user may be able to use a touchpad to navigate through the rows of numbers to select a PIN. For example, the user may be able to move the cursor through the rows of numbers by moving his fingers over the touchpad. Accordingly, the touchpad may provide the user with an alternative to using head movements to enter some or all of the numbers from the unlock sequence.

Further, the PIN could include other types of characters and/or symbols (e.g., letters, punctuation, and so on), in addition or in the alternative to numbers. Accordingly, in some embodiments, the rows in a lock screen may also include other types of characters and/or symbols.

### II. Example Wearable Computing Devices

Systems and devices in which example embodiments may be implemented will now be described in greater detail. In general, an example system may be implemented in or may take the form of a wearable computer (also referred to as a wearable computing device). In an example embodiment, a wearable computer takes the form of or includes a head-mountable device (HMD).

It should be understood, however, that example systems may also be implemented in or take the form of other devices, such as a mobile phone, a tablet computer, or a personal computer, among other possibilities. Further, an example system may take the form of non-transitory computer readable medium, which has program instructions stored thereon that are executable by at a processor to provide the functionality described herein. An example system may also take the form of a device such as a wearable computer or mobile phone, or a subsystem of such a device, which includes a non-transitory computer readable medium having such program instructions stored thereon.

An HMD may generally be any display device that is capable of being worn on the head and, when worn, is configured to place a display in front of one or both eyes of the wearer. An HMD may take various forms such as a helmet or eyeglasses. As such, references to “eyeglasses” or a “glasses-style” HMD should be understood to refer to any HMD that has a glasses-like frame so that it can be worn on the head. Note, however, that a glasses-style HMD may or may not include a lens in front of one or both eyes. Further, example embodiments may be implemented by or in association with an HMD with a single display or with two displays, which may be referred to as a “monocular” HMD or a “binocular” HMD, respectively.

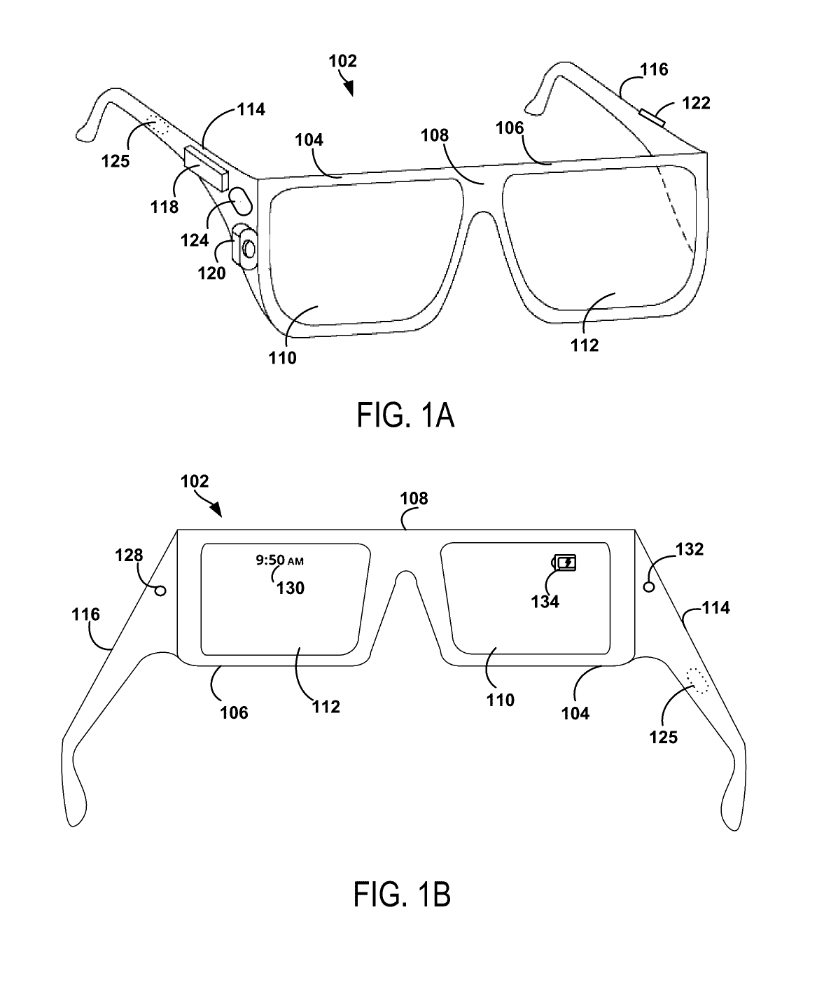

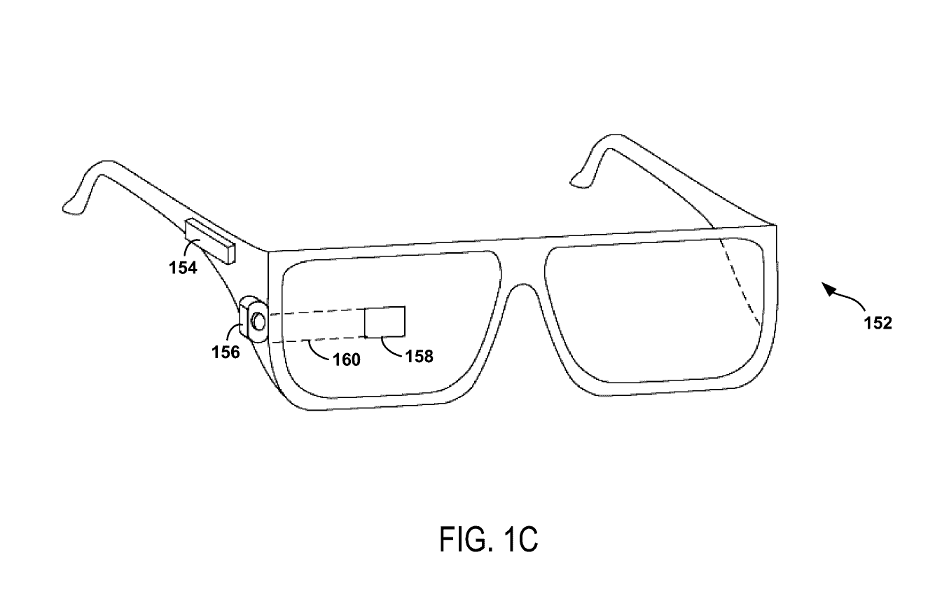

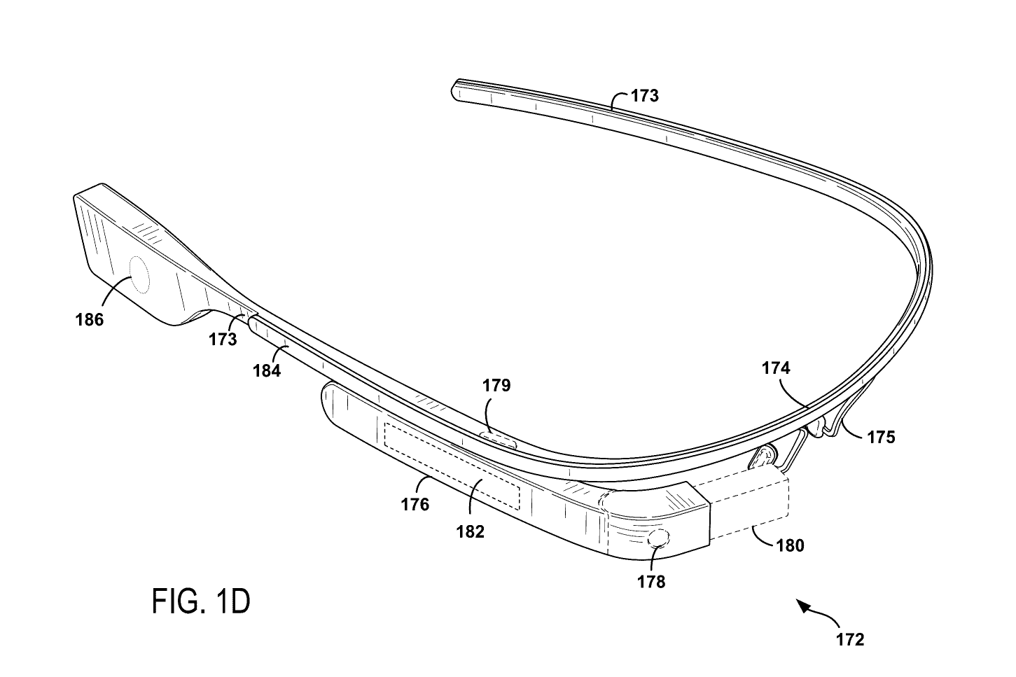

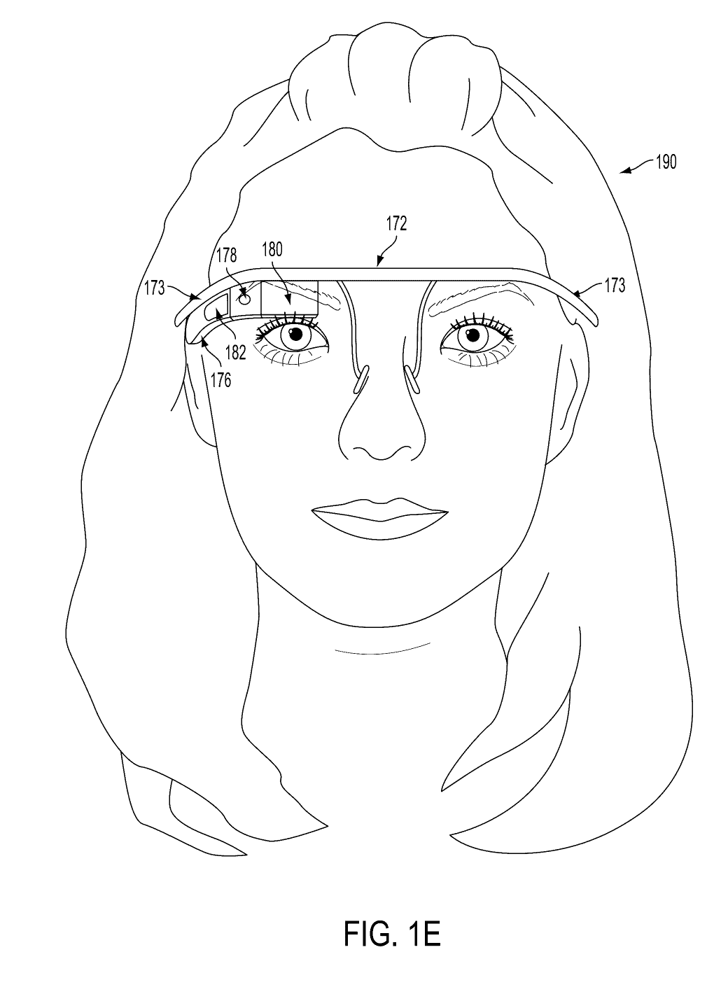

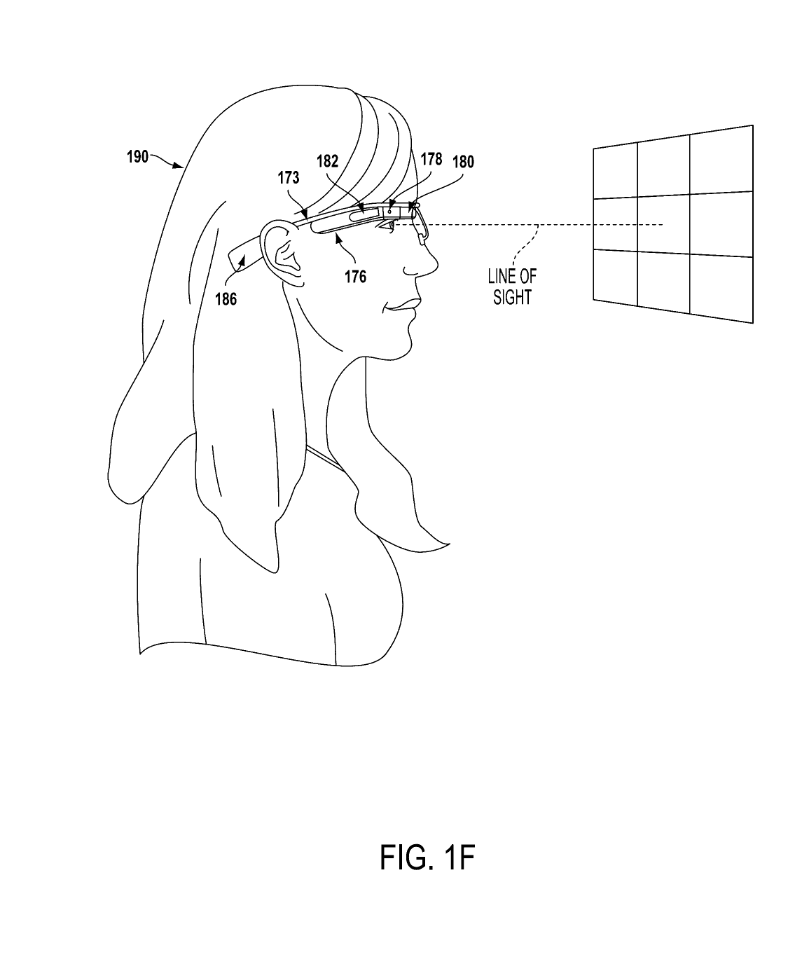

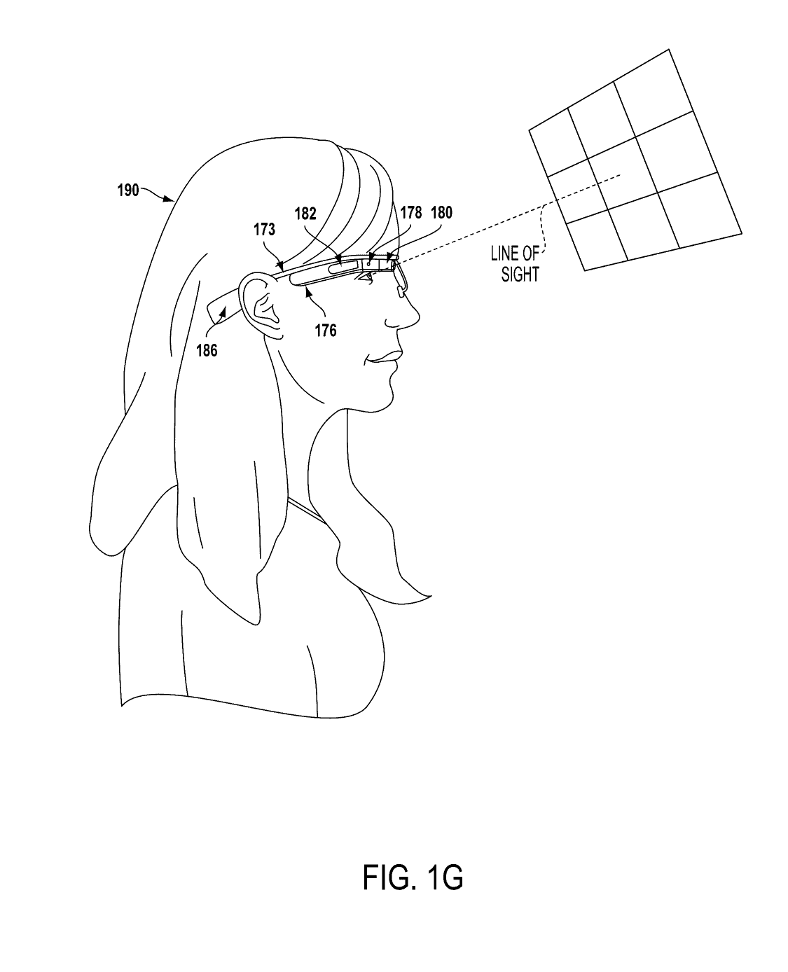

FIG. 1A illustrates a wearable computing system according to an example embodiment. In FIG. 1A, the wearable computing system takes the form of a head-mountable device (HMD) 102 (which may also be referred to as a head-mounted display). It should be understood, however, that example systems and devices may take the form of or be implemented within or in association with other types of devices, without departing from the scope of the invention. As illustrated in FIG. 1A, the HMD 102 includes frame elements including lens-frames 104, 106 and a center frame support 108, lens elements 110, 112, and extending side-arms 114, 116. The center frame support 108 and the extending side-arms 114, 116 are configured to secure the HMD 102 to a user's face via a user's nose and ears, respectively.

Each of the frame elements 104, 106, and 108 and the extending side-arms 114, 116 may be formed of a solid structure of plastic and/or metal, or may be formed of a hollow structure of similar material so as to allow wiring and component interconnects to be internally routed through the HMD 102. Other materials may be possible as well.

One or more of each of the lens elements 110, 112 may be formed of any material that can suitably display a projected image or graphic. Each of the lens elements 110, 112 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 114, 116 may each be projections that extend away from the lens-frames 104, 106, respectively, and may be positioned behind a user's ears to secure the HMD 102 to the user. The extending side-arms 114, 116 may further secure the HMD 102 to the user by extending around a rear portion of the user's head. Additionally or alternatively, for example, the HMD 102 may connect to or be affixed within a head-mounted helmet structure. Other configurations for an HMD are also possible.

The HMD 102 may also include an on-board computing system 118, an image capture device 120, a sensor 122, and a finger-operable touchpad 124. The on-board computing system 118 is shown to be positioned on the extending side-arm 114 of the HMD 102; however, the on-board computing system 118 may be provided on other parts of the HMD 102 or may be positioned remote from the HMD 102 (e.g., the on-board computing system 118 could be wire- or wirelessly-connected to the HMD 102). The on-board computing system 118 may include a processor and memory, for example. The on-board computing system 118 may be configured to receive and analyze data from the image capture device 120 and the finger-operable touchpad 124 (and possibly from other sensory devices, user interfaces, or both) and generate images for output by the lens elements 110 and 112.

The image capture device 120 may be, for example, a camera that is configured to capture still images and/or to capture video. In the illustrated configuration, image capture device 120 is positioned on the extending side-arm 114 of the HMD 102; however, the image capture device 120 may be provided on other parts of the HMD 102. The image capture device 120 may be configured to capture images at various resolutions or at different frame rates. Many image capture devices with a small form-factor, such as the cameras used in mobile phones or webcams, for example, may be incorporated into an example of the HMD 102.

Further, although FIG. 1A illustrates one image capture device 120, more image capture device may be used, and each may be configured to capture the same view, or to capture different views. For example, the image capture device 120 may be forward facing to capture at least a portion of the real-world view perceived by the user. This forward facing image captured by the image capture device 120 may then be used to generate an augmented reality where computer generated images appear to interact with or overlay the real-world view perceived by the user.

The sensor 122 is shown on the extending side-arm 116 of the HMD 102; however, the sensor 122 may be positioned on other parts of the HMD 102. For illustrative purposes, only one sensor 122 is shown. However, in an example embodiment, the HMD 102 may include multiple sensors. For example, an HMD 102 may include sensors 102 such as one or more gyroscopes, one or more accelerometers, one or more magnetometers, one or more light sensors, one or more infrared sensors, and/or one or more microphones. Other sensing devices may be included in addition or in the alternative to the sensors that are specifically identified herein.

The finger-operable touchpad 124 is shown on the extending side-arm 114 of the HMD 102. However, the finger-operable touchpad 124 may be positioned on other parts of the HMD 102. Also, more than one finger-operable touchpad may be present on the HMD 102. The finger-operable touchpad 124 may be used by a user to input commands. The finger-operable touchpad 124 may sense at least one of a pressure, position and/or a movement of one or more fingers via capacitive sensing, resistance sensing, or a surface acoustic wave process, among other possibilities. The finger-operable touchpad 124 may be capable of sensing movement of one or more fingers simultaneously, in addition to sensing movement in a direction parallel or planar to the pad surface, in a direction normal to the pad surface, or both, and may also be capable of sensing a level of pressure applied to the touchpad surface. In some embodiments, the finger-operable touchpad 124 may be formed of one or more translucent or transparent insulating layers and one or more translucent or transparent conducting layers. Edges of the finger-operable touchpad 124 may be formed to have a raised, indented, or roughened surface, so as to provide tactile feedback to a user when the user's finger reaches the edge, or other area, of the finger-operable touchpad 124. If more than one finger-operable touchpad is present, each finger-operable touchpad may be operated independently, and may provide a different function.

In a further aspect, HMD 102 may be configured to receive user input in various ways, in addition or in the alternative to user input received via finger-operable touchpad 124. For example, on-board computing system 118 may implement a speech-to-text process and utilize a syntax that maps certain spoken commands to certain actions. In addition, HMD 102 may include one or more microphones via which a wearer's speech may be captured. Configured as such, HMD 102 may be operable to detect spoken commands and carry out various computing functions that correspond to the spoken commands.

As another example, HMD 102 may interpret certain head-movements as user input. For example, when HMD 102 is worn, HMD 102 may use one or more gyroscopes and/or one or more accelerometers to detect head movement. The HMD 102 may then interpret certain head-movements as being user input, such as nodding, or looking up, down, left, or right. An HMD 102 could also pan or scroll through graphics in a display according to movement. Other types of actions may also be mapped to head movement.

As yet another example, HMD 102 may interpret certain gestures (e.g., by a wearer's hand or hands) as user input. For example, HMD 102 may capture hand movements by analyzing image data from image capture device 120, and initiate actions that are defined as corresponding to certain hand movements.

As a further example, HMD 102 may interpret eye movement as user input. In particular, HMD 102 may include one or more inward-facing image capture devices and/or one or more other inward-facing sensors (not shown) that may be used to track eye movements and/or determine the direction of a wearer's gaze. As such, certain eye movements may be mapped to certain actions. For example, certain actions may be defined as corresponding to movement of the eye in a certain direction, a blink, and/or a wink, among other possibilities.

HMD 102 also includes a speaker 125 for generating audio output. In one example, the speaker could be in the form of a bone conduction speaker, also referred to as a bone conduction transducer (BCT). Speaker 125 may be, for example, a vibration transducer or an electroacoustic transducer that produces sound in response to an electrical audio signal input. The frame of HMD 102 may be designed such that when a user wears HMD 102, the speaker 125 contacts the wearer. Alternatively, speaker 125 may be embedded within the frame of HMD 102 and positioned such that, when the HMD 102 is worn, speaker 125 vibrates a portion of the frame that contacts the wearer. In either case, HMD 102 may be configured to send an audio signal to speaker 125, so that vibration of the speaker may be directly or indirectly transferred to the bone structure of the wearer. When the vibrations travel through the bone structure to the bones in the middle ear of the wearer, the wearer can interpret the vibrations provided by BCT 125 as sounds.

Various types of bone-conduction transducers (BCTs) may be implemented, depending upon the particular implementation. Generally, any component that is arranged to vibrate the HMD 102 may be incorporated as a vibration transducer. Yet further it should be understood that an HMD 102 may include a single speaker 125 or multiple speakers. In addition, the location(s) of speaker(s) on the HMD may vary, depending upon the implementation. For example, a speaker may be located proximate to a wearer's temple (as shown), behind the wearer's ear, proximate to the wearer's nose, and/or at any other location where the speaker 125 can vibrate the wearer's bone structure.

FIG. 1B illustrates an alternate view of the wearable computing device illustrated in FIG. 1A. As shown in FIG. 1B, the lens elements 110, 112 may act as display elements. The HMD 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may not be used (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 104, 106 for driving such a matrix display. Alternatively or additionally, a laser or LED source and scanning system could be used to draw a raster display directly onto the retina of one or more of the user's eyes. Other possibilities exist as well.

FIG. 1C illustrates another wearable computing system according to an example embodiment, which takes the form of an HMD 152. The HMD 152 may include frame elements and side-arms such as those described with respect to FIGS. 1A and 1B. The HMD 152 may additionally include an on-board computing system 154 and an image capture device 156, such as those described with respect to FIGS. 1A and 1B. The image capture device 156 is shown mounted on a frame of the HMD 152. However, the image capture device 156 may be mounted at other positions as well.

As shown in FIG. 1C, the HMD 152 may include a single display 158 which may be coupled to the device. The display 158 may be formed on one of the lens elements of the HMD 152, such as a lens element described with respect to FIGS. 1A and 1B, and may be configured to overlay computer-generated graphics in the user's view of the physical world. The display 158 is shown to be provided in a center of a lens of the HMD 152, however, the display 158 may be provided in other positions, such as for example towards either the upper or lower portions of the wearer's field of view. The display 158 is controllable via the computing system 154 that is coupled to the display 158 via an optical waveguide 160.

FIG. 1D illustrates another wearable computing system according to an example embodiment, which takes the form of a monocular HMD 172. The HMD 172 may include side-arms 173, a center frame support 174, and a bridge portion with nosepiece 175. In the example shown in FIG. 1D, the center frame support 174 connects the side-arms 173. The HMD 172 does not include lens-frames containing lens elements. The HMD 172 may additionally include a component housing 176, which may include an on-board computing system (not shown), an image capture device 178, and a button 179 for operating the image capture device 178 (and/or usable for other purposes). Component housing 176 may also include other electrical components and/or may be electrically connected to electrical components at other locations within or on the HMD. HMD 172 also includes a BCT 186.

The HMD 172 may include a single display 180, which may be coupled to one of the side-arms 173 via the component housing 176. In an example embodiment, the display 180 may be a see-through display, which is made of glass and/or another transparent or translucent material, such that the wearer can see their environment through the display 180. Further, the component housing 176 may include the light sources (not shown) for the display 180 and/or optical elements (not shown) to direct light from the light sources to the display 180. As such, display 180 may include optical features that direct light that is generated by such light sources towards the wearer's eye, when HMD 172 is being worn.

In a further aspect, HMD 172 may include a sliding feature 184, which may be used to adjust the length of the side-arms 173. Thus, sliding feature 184 may be used to adjust the fit of HMD 172. Further, an HMD may include other features that allow a wearer to adjust the fit of the HMD, without departing from the scope of the invention.

FIGS. 1E to 1G are simplified illustrations of the HMD 172 shown in FIG. 1D, being worn by a wearer 190. As shown in FIG. 1F, when HMD 172 is worn, BCT 186 is arranged such that when HMD 172 is worn, BCT 186 is located behind the wearer's ear. As such, BCT 186 is not visible from the perspective shown in FIG. 1E.

In the illustrated example, the display 180 may be arranged such that when HMD 172 is worn, display 180 is positioned in front of or proximate to a user's eye when the HMD 172 is worn by a user. For example, display 180 may be positioned below the center frame support and above the center of the wearer's eye, as shown in FIG. 1E. Further, in the illustrated configuration, display 180 may be offset from the center of the wearer's eye (e.g., so that the center of display 180 is positioned to the right and above of the center of the wearer's eye, from the wearer's perspective).

Configured as shown in FIGS. 1E to 1G, display 180 may be located in the periphery of the field of view of the wearer 190, when HMD 172 is worn. Thus, as shown by FIG. 1F, when the wearer 190 looks forward, the wearer 190 may see the display 180 with their peripheral vision. As a result, display 180 may be outside the central portion of the wearer's field of view when their eye is facing forward, as it commonly is for many day-to-day activities. Such positioning can facilitate unobstructed eye-to-eye conversations with others, as well as generally providing unobstructed viewing and perception of the world within the central portion of the wearer's field of view. Further, when the display 180 is located as shown, the wearer 190 may view the display 180 by, e.g., looking up with their eyes only (possibly without moving their head). This is illustrated as shown in FIG. 1G, where the wearer has moved their eyes to look up and align their line of sight with display 180. A wearer might also use the display by tilting their head down and aligning their eye with the display 180.

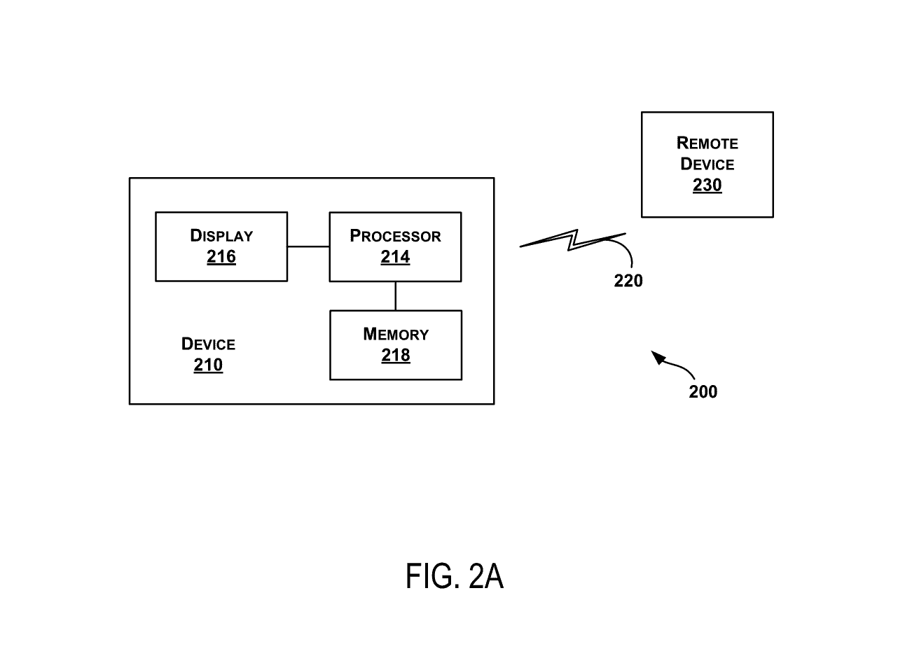

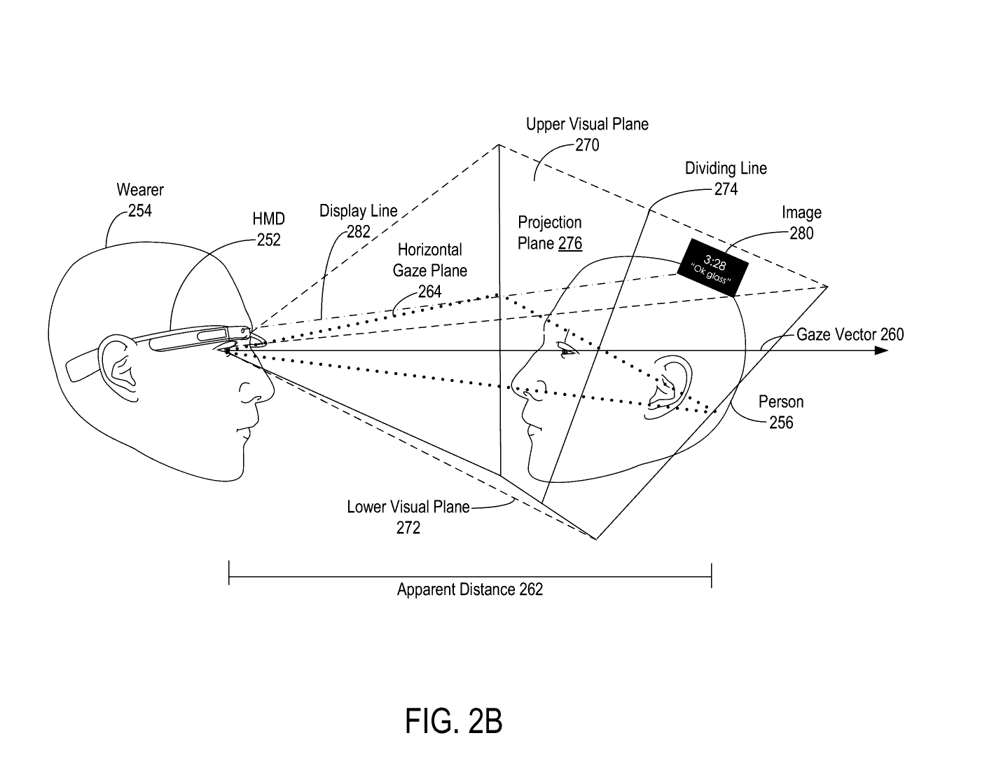

FIG. 2A is a simplified block diagram a computing device 210 according to an example embodiment. In an example embodiment, device 210 communicates using a communication link 220 (e.g., a wired or wireless connection) to a remote device 230. The device 210 may be any type of device that can receive data and display information corresponding to or associated with the data. For example, the device 210 may take the form of or include a head-mountable display, such as the head-mounted devices 102, 152, or 172 that are described with reference to FIGS. 1A to 1G.

The device 210 may include a processor 214 and a display 216. The display 216 may be, for example, an optical see-through display, an optical see-around display, or a video see-through display. The processor 214 may receive data from the remote device 230, and configure the data for display on the display 216. The processor 214 may be any type of processor, such as a micro-processor or a digital signal processor, for example.

The device 210 may further include on-board data storage, such as memory 218 coupled to the processor 214. The memory 218 may store software that can be accessed and executed by the processor 214, for example.

The remote device 230 may be any type of computing device or transmitter including a laptop computer, a mobile telephone, head-mountable display, tablet computing device, etc., that is configured to transmit data to the device 210. The remote device 230 and the device 210 may contain hardware to enable the communication link 220, such as processors, transmitters, receivers, antennas, etc.

Further, remote device 230 may take the form of or be implemented in a computing system that is in communication with and configured to perform functions on behalf of client device, such as computing device 210. Such a remote device 230 may receive data from another computing device 210 (e.g., an HMD 102, 152, or 172 or a mobile phone), perform certain processing functions on behalf of the device 210, and then send the resulting data back to device 210. This functionality may be referred to as “cloud” computing.

In FIG. 2A, the communication link 220 is illustrated as a wireless connection; however, wired connections may also be used. For example, the communication link 220 may be a wired serial bus such as a universal serial bus or a parallel bus. A wired connection may be a proprietary connection as well. The communication link 220 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 230 may be accessible via the Internet and may include a computing cluster associated with a particular web service (e.g., social-networking, photo sharing, address book, etc.).

FIG. 2B shows an example projection of UI elements described herein via an image 280 by an example head-mountable device (HMD) 252, according to an example embodiment. Other configurations of an HMD may be also be used to present the UI described herein via image 280. FIG. 2B shows wearer 254 of HMD 252 looking at an eye of person 256. As such, wearer 254's gaze, or direction of viewing, is along gaze vector 260. A horizontal plane, such as horizontal gaze plane 264 can then be used to divide space into three portions: space above horizontal gaze plane 264, space in horizontal gaze plane 264, and space below horizontal gaze plane 264. In the context of projection plane 276, horizontal gaze plane 260 appears as a line that divides projection plane into a subplane above the line of horizontal gaze plane 260, a subplane a subspace below the line of horizontal gaze plane 260, and the line where horizontal gaze plane 260 intersects projection plane 276. In FIG. 2B, horizontal gaze plane 264 is shown using dotted lines.

Additionally, a dividing plane, indicated using dividing line 274 can be drawn to separate space into three other portions: space to the left of the dividing plane, space on the dividing plane, and space to right of the dividing plane. In the context of projection plane 276, the dividing plane intersects projection plane 276 at dividing line 274. Thus the dividing plane divides projection plane into: a subplane to the left of dividing line 274, a subplane to the right of dividing line 274, and dividing line 274. In FIG. 2B, dividing line 274 is shown as a solid line.

Humans, such wearer 254, when gazing in a gaze direction, may have limits on what objects can be seen above and below the gaze direction. FIG. 2B shows the upper visual plane 270 as the uppermost plane that wearer 254 can see while gazing along gaze vector 260, and shows lower visual plane 272 as the lowermost plane that wearer 254 can see while gazing along gaze vector 260. In FIG. 2B, upper visual plane 270 and lower visual plane 272 are shown using dashed lines.

The HMD can project an image for view by wearer 254 at some apparent distance 262 along display line 282, which is shown as a dotted and dashed line in FIG. 2B. For example, apparent distance 262 can be 1 meter, four feet, infinity, or some other distance. That is, HMD 252 can generate a display, such as image 280, which appears to be at the apparent distance 262 from the eye of wearer 254 and in projection plane 276. In this example, image 280 is shown between horizontal gaze plane 264 and upper visual plane 270; that is image 280 is projected above gaze vector 260. In this example, image 280 is also projected to the right of dividing line 274. As image 280 is projected above and to the right of gaze vector 260, wearer 254 can look at person 256 without image 280 obscuring their general view. In one example, the display element of the HMD 252 is translucent when not active (i.e. when image 280 is not being displayed), and so the wearer 254 can perceive objects in the real world along the vector of display line 282.

Other example locations for displaying image 280 can be used to permit wearer 254 to look along gaze vector 260 without obscuring the view of objects along the gaze vector. For example, in some embodiments, image 280 can be projected above horizontal gaze plane 264 near and/or just above upper visual plane 270 to keep image 280 from obscuring most of wearer 254's view. Then, when wearer 254 wants to view image 280, wearer 254 can move their eyes such that their gaze is directly toward image 280.

### III. Example Methods

A. Unlocking Based on a Sequence of Numbers

As noted above, a predetermined unlock sequence may correspond to a sequence of two or more numbers selected from the rows of numbers. In such an embodiment, the HMD's user may use head movements to move a graphic icon (and thus a corresponding input region) with respect to the rows of numbers. The user may select particular numbers from the rows of numbers by, e.g., navigating the input region through each particular number.

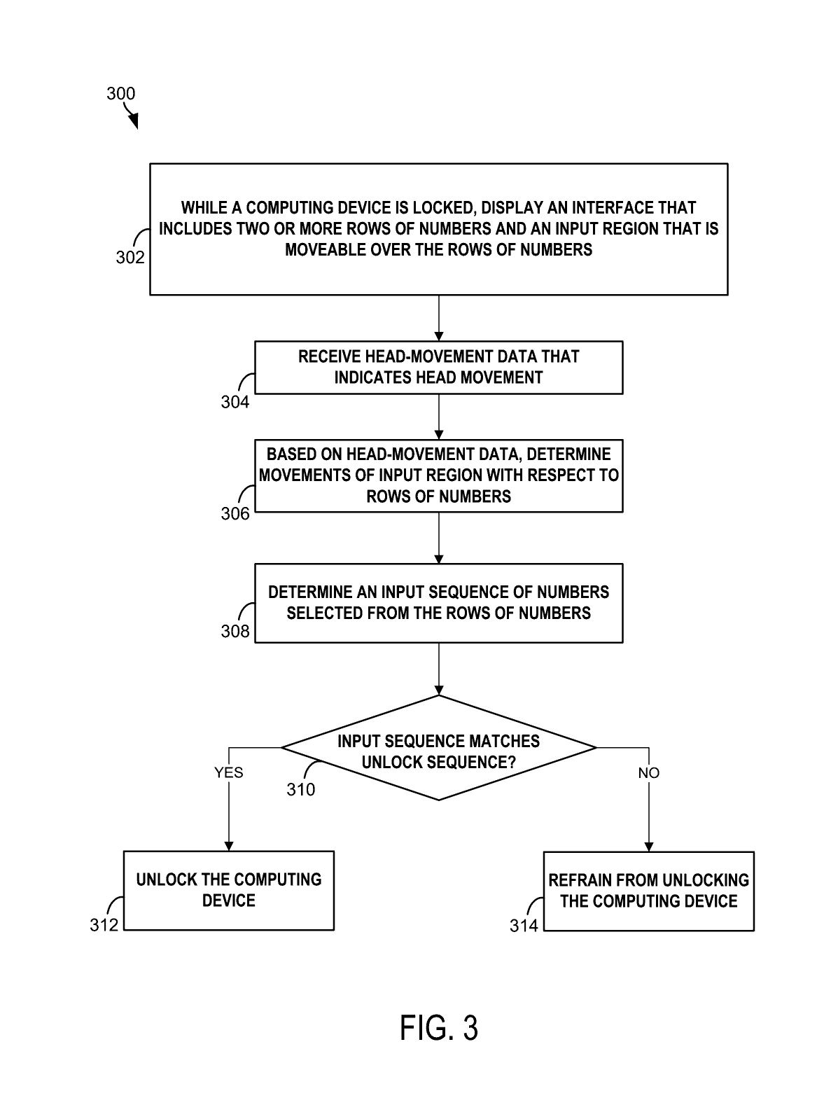

FIG. 3 is a flow chart illustrating a method 300, according to an example embodiment. In particular, method 300 may be implemented to help provide an unlock screen via which a user can enter an unlock sequence by sequentially selecting numbers from the rows of numbers that form the user's unlock sequence.

More specifically, while a computing device is locked, the computing device may display an interface that includes two or more rows of numbers and an input region that is moveable over the rows of numbers, as shown by block 302. The computing device may then receive head-movement data, which is indicative of head movement, as shown by block 304. Based at least in part on the head-movement data, the computing device may determine one or more movements of the input region with respect to the rows of numbers, as shown by block 306. Further, the computing device may determine an input sequence based on numbers selected from the rows of numbers by movement of the input region, as shown by block 308.

In order to determine whether to unlock, the computing device may determine whether or not the input sequence matches a predetermined unlock sequence, as shown by block 310. In an example embodiment, the unlock sequence may be a predetermined sequence of two or more numbers. If the input sequence matches the predetermined unlock sequence, then the computing device initiates an unlock procedure, as shown by block 312. And, if the input sequence does not match the predetermined unlock sequence, then the computing device refrains from initiating the unlock procedure, as shown by block 314.

In an example embodiment, numbers selected for the input sequence may be determined based on where the input region crosses each row of numbers. For example, a number may be selected from a row of numbers when the input region crosses the bottom of the number. The selected number may be the number that is closest to the center of the input region when the input region crosses the row of numbers. Other configurations are also possible. For example, a number may be selected when the input region crosses the top of the row of numbers, or when the input region crosses the middle of the row of numbers.

In a further embodiment, previously selected numbers for the input sequence may be unselected by the user. For example, a number may be unselected based on when the input region crosses the row of numbers in the reverse direction. For example, a number may be unselected when the input region crosses back through the top of the row of numbers containing the previously selected number. Alternatively, the number may only be unselected if the input region crosses back through the previously selected number (as opposed to elsewhere within the row). Other configurations are also possible. For example, a number may be unselected when the input region crosses back through the bottom of the row of numbers in the reverse direction, or when the input region crosses back through the middle of the row of numbers.

In an additional embodiment, numbers may be selected or unselected based on gesture data corresponding to various types of gestures, which may be detected via various types of interfaces. In an example embodiment, the gesture data may correspond to gestures on a touch-based interface, such as taps and/or swipes on a touchpad or touchscreen. For instance, an HMD such as HMD 172 of FIG. 1D, may detect taps on a side-mounted touchpad 182. Accordingly, a user that is wearing HMD 172 may input an unlock sequence by using head movements to move the input region to the numbers in the unlock sequence, and then tapping the side-mounted touchpad 182 as the input region moves over each number in the sequence. One tap may be used to select a given number. A second tap or a tap to a different location on the touchpad may be used to unselect the number.

In other embodiments, the gesture data may correspond to hand gestures made in the air. Such hand gestures may be detected by a camera and/or by proximity sensor(s), for example. In such an embodiment, the user may input the unlock sequence by performing a certain hand movement each time the input region moves over a number in the unlock sequence. A second hand movement or a different type of hand movement may be used to unselect the number.

In yet other embodiments, the gesture data may correspond to eye gestures such as winks and/or certain directional eye movements. In such an embodiment, the eye gestures may be detected by an eye- or gaze-tracking system of an HMD. For example, the user may input the unlock sequence by winking each time the input region moves over a number in the unlock sequence. A second wink or different type of eye movement may be used to unselect the number.

In yet other embodiments, the gesture data may correspond to input actions on a mechanical interface, such as a mouse, keyboard, or button on an HMD, among other possibilities. For example, the user may input the unlock sequence by pressing a button on the HMD, on a keyboard, or on mouse each time the input sequence moves over a number in the unlock sequence. A second input action or a different type of input action may be used to unselect the number. Other examples are possible.

In some embodiments, at block 312, the function of determining whether or not the input sequence matches the predetermined unlock sequence may be performed on the fly, as each number in the input sequence is detected. For example, each time a new number is selected, the computing device may compare the newly-identified number to the next number in the sequence making up the unlock sequence. If the newly-inputted number matches the next number in the unlock sequence, then the computing device may continue the unlock process and wait for the next number (or, if the newly-inputted number is the last number in the sequence making up the unlock sequence, the computing device may determine that the unlock sequence is correct and responsively unlock).

On the other hand, if a newly-inputted number does not match the next number in the unlock sequence, then the computing device may reset the unlock process, and indicate to the user that there is been an error. Alternatively, when a newly-inputted number does not match the next number in the unlock sequence, the computing device may indicate this to the user and allow the user one or more additional attempts to enter the next number correctly. Further, the computing device may limit the number of additional attempts that can be made to input a given number in the unlock sequence, and/or may limit the number of total additional attempts to input numbers that can be made during the entire process of inputting the unlock sequence.

In other embodiments, the computing device may not compare numbers as they are received. Instead, at block 310, the computing device may wait until the input sequence is completely entered (e.g., until as many numbers have been inputted as are contained in the unlock sequence), and then determine whether the input sequence matches the predetermined unlock sequence. If the input sequence does match the predetermined unlock sequence, an unlock process may be triggered. If the input sequence does not match the predetermined unlock sequence, an error message may be displayed to the user. In that case, the device may go to sleep until the user reinitiates the unlock process. Alternatively, the unlock process may be restarted immediately and the rows of numbers may be displayed with all of the selections cleared. In an additional embodiment, the user may be given the ability to navigate back up to correct the pin. Previously selected numbers could be unselected, for example, by using one of the procedures for unselecting numbers described above.

In further embodiments, more rows of numbers may be displayed to the user than are needed to enter the PIN. For example, as the user navigates down through the rows of numbers, more rows of numbers may continue to be displayed, regardless of the PIN length. Accordingly, an additional layer of security may be added because the length of the PIN may not be readily apparent from the display. In such embodiments, the user may be required to indicate when he is done entering the PIN by, for example, giving a specific voice command or tapping the touchpad.

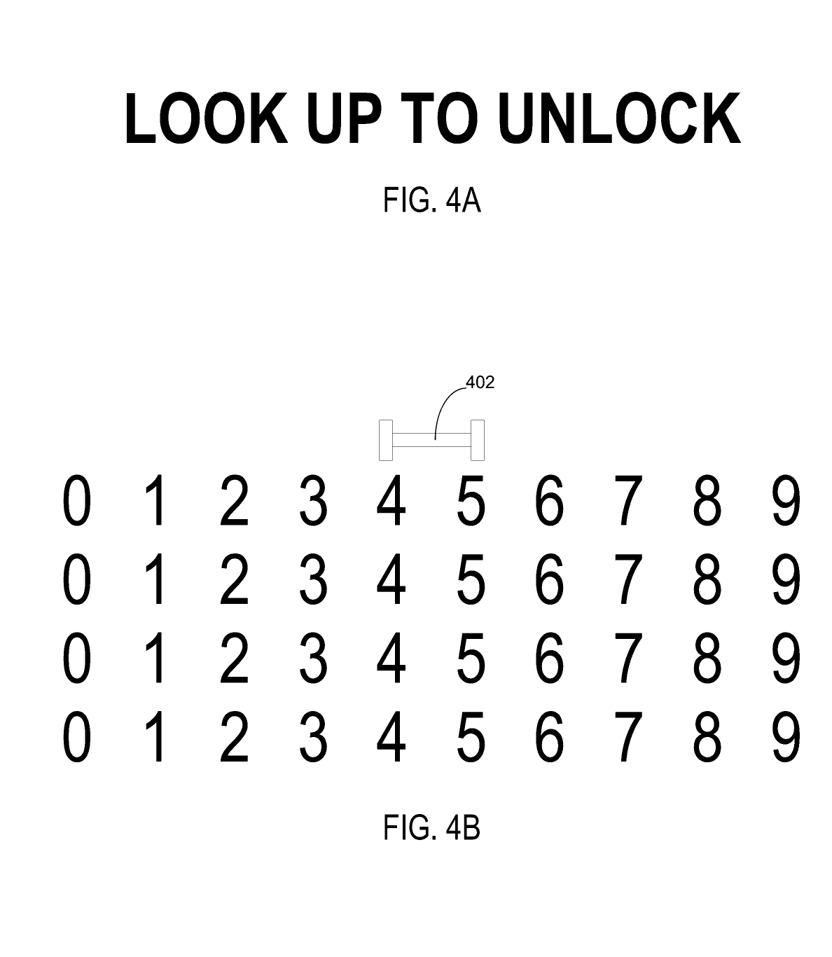

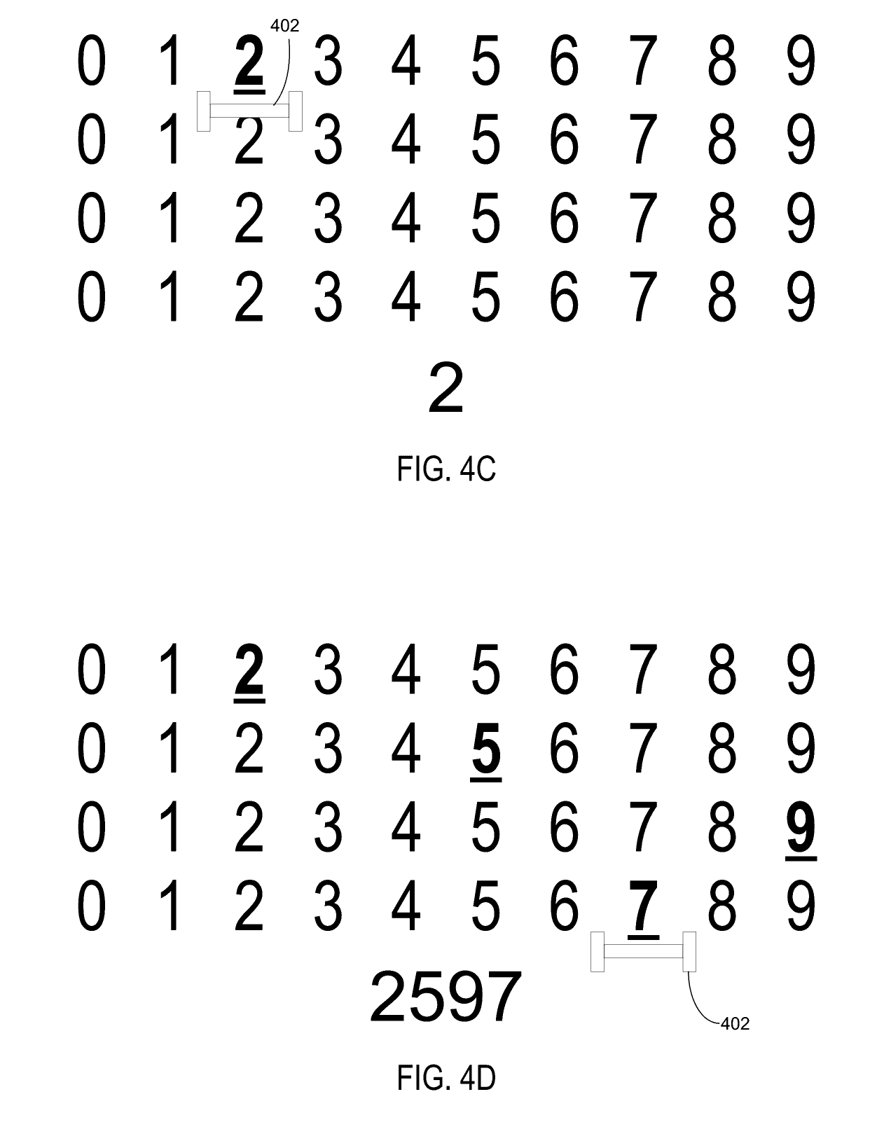

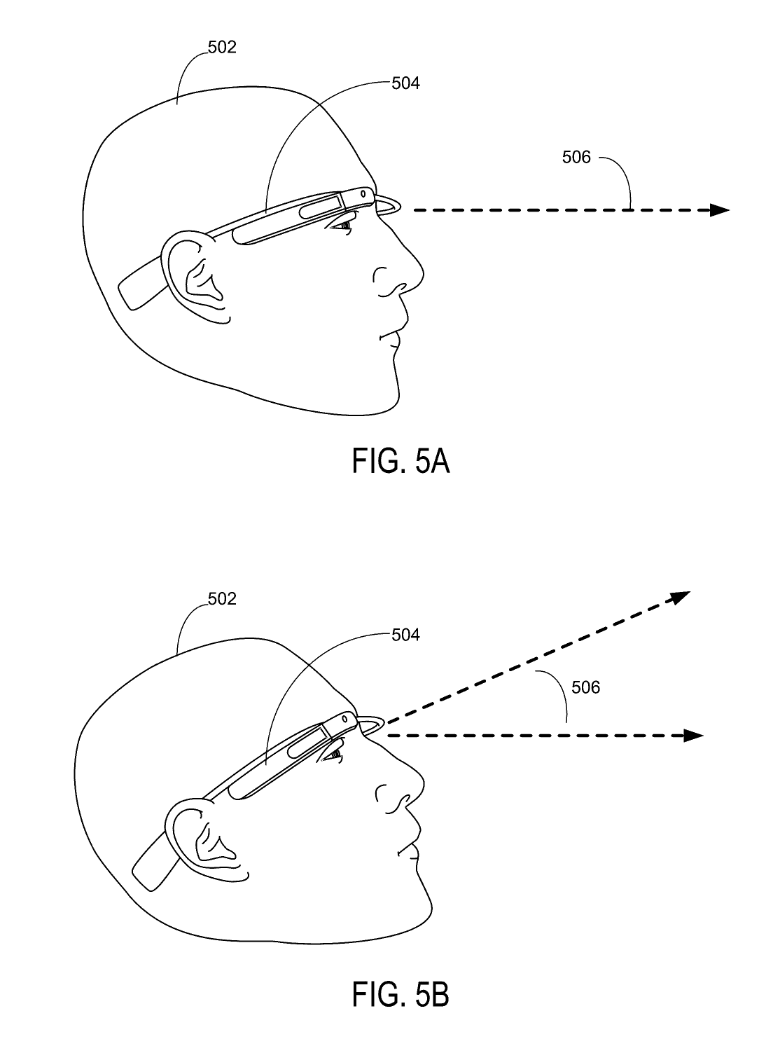

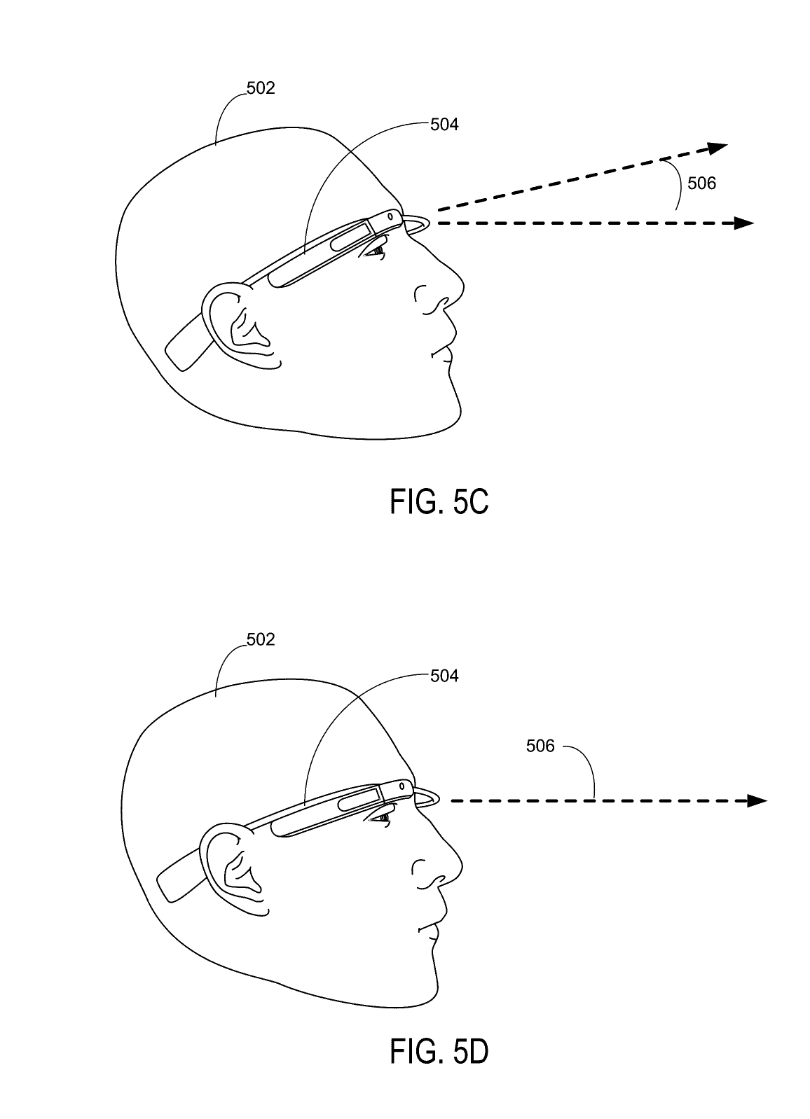

FIGS. 4A to 4D illustrate an example sequence of screenshots of an HMD's display, as a user enters an unlock sequence. FIGS. 5A to 5D illustrate a sequence of user head movements corresponding to the screenshots of FIGS. 4A to 4D. The lock screen is described below by way of example as being displayed by an HMD. However, the lock screen described herein may be implemented by other types of computing devices without departing from the scope of the invention.

The HMD 504 may initially display a message to the user, indicating that the user may look up in order to initiate the unlock procedure, as shown in FIG. 4A. The user's head 502 may initially be horizontal, as show in FIG. 5A. The HMD 504 may then detect user head movement data that indicates that the user is tilting his head 502 upward, as shown in FIG. 5B. After the user tilts his head beyond a certain threshold angle 506, the HMD 504 may initiate the unlock procedure by displaying to the user rows of numbers as shown in FIG. 4B. In an example embodiment, the angle 506 may be 30 degrees above parallel. Other threshold angles may also be used.

As shown in FIG. 4B, rows of numbers may be displayed to the user. When the HMD 504 displays the rows of numbers, the HMD may initially display a graphic representation of an input region 402 above the rows of numbers. The HMD 504 may then move the input region 402 with respect to the rows of numbers based on the wearer's head movements. More specifically, HMD may move the input region 402 based on movement of the HMD, as indicated by sensors on the HMD such as accelerometer(s), gyroscope(s), and/or magnetometer(s), which is considered to be indicative of head movement of the HMD wearer.

Further, in some embodiments, a computing device may visually present movement of the input region 402 with respect to the rows of numbers by moving the rows of numbers in the display, while keeping the input region at the same location in the display (e.g., in the center of the display). For instance, an HMD's display may effectively function as a viewing window to a portion of the rows of numbers, and the HMD may move the viewing window based on the head movement.

As the HMD 504 detects head movement, the HMD may move the rows of numbers with respect to the display, while keeping the input region 402 centered in the display. In particular, the HMD 504 may detect head movement to the left and responsively move the rows of numbers to the right in the display. Further, the HMD 504 may detect head movement downward and responsively move the rows of numbers upwards in the display. Accordingly, the position of the input region relative to the rows of numbers may be controlled by user head movements, as shown by the change in position of the input region relative to the rows of numbers between the screenshot in FIG. 4B and the screenshot in FIG. 4C. Thus, by causing the input region 402 to cross the bottom of the first row of numbers through the “2,” as shown in the screenshot in FIG. 4C, the user has selected “2” as the first number in the unlock sequence.

As shown in FIG. 4C, the display may contain a graphical indication to indicate to the user which numbers have been selected for the PIN. In this case, the selected number (the “2” in the first row of numbers) has been bolded and underlined. Additionally, the selected numbers are displayed separately to the user underneath the rows of numbers. The selected numbers may also be presented in a different color, presented with a different font, and/or increased in size after they are selected. Further, the selected numbers may be separately displayed to the user somewhere else on the display. Other variations to the selected numbers and/or the visual representation of the selected numbers are also possible.

As the user of the HMD 504 tilts his head 502 downward, the angle 506 of his head above parallel decreases, as shown between FIG. 5B and FIG. 5C. In an example embodiment, a decrease in the angle 506 of the user's head 502 above parallel may result in a proportional movement down of the input region 402 relative to the rows of numbers. For example, if the user must tilt his head upward 30 degrees in order to initiate the unlock procedure and display 4 rows of numbers, a downward tilt of 7.5 degrees (30/4) may result in the input region 402 moving down from the first row to the second row, as shown in FIG. 4C.

In additional embodiments, the HMD 504 may be designed to ignore minor upward and downward movements of the user's head 502 in order to improve the user experience. For example, a user's head movement may be required to be above a certain threshold angle and/or beyond a certain threshold speed in order to cause of a movement of the input region 402 relative to the rows of numbers. In a further embodiment, the input region 402 may always be locked in to a single row of numbers. Accordingly, the user may be required to move his head 502 downward or upward beyond a certain threshold angle in order to move the input region 402 vertically from the middle of one row of numbers to the middle of the next row of numbers. Further, the row containing the input region in this example embodiment may be highlighted or otherwise graphically indicated to the user.

Similarly, the HMD 504 may be designed to ignore minor movements of the user's head 502 to the left and right. For example, a user's head movement may be required to be above a certain threshold angle and/or beyond a certain threshold speed in order to cause of a movement of the input region 402 left or right within a row of numbers. In a further embodiment, the input region 402 may always be locked in to a single number within a row of numbers. Accordingly, the user may be required to move his head 502 to the left or right beyond a certain threshold angle in order to move the input region 402 horizontally from the middle of one number to the middle of a neighboring number in the row. Further, the input region in this example embodiment may simply highlight or otherwise graphically indicate to the user the number currently covered by the input region.

After a number in the first row of numbers has been selected, the HMD 504 may then detect additional head movements to the left and to the right as the user navigates the input region 402 horizontally across the numbers within a given row of numbers. In particular, the HMD 504 may detect head movement to the left and responsively move the rows of numbers to the right in the display. Further, the HMD 504 may detect head movement to the right and responsively move the rows of numbers to the left in the display. In an example embodiment, the input region may be prevented from moving past the last number on each of end of the rows of numbers.

Additionally, the HMD 504 may detect further head movement downward and responsively move the rows of numbers upwards in the display. Numbers may be selected from the rows of numbers based on where the input region 402 crosses each row of numbers. FIG. 4D shows a screenshot of the display after the user has selected the unlock sequence “2597” by causing the input region 402 to cross through the “2” in the first row of numbers, the “5” in the second row of numbers, the “9” in the third row of numbers, and the “7” in the last row of numbers. At this point, the HMD 504 may verify that the unlock sequence has been entered correctly, and responsively unlock.

In an example embodiment, the angle 506 of the user's head 502 above parallel may control the vertical position of the input region 402 relative to the rows of numbers in the display such that when the user has selected all of the numbers required to enter the PIN, the user will have moved his head 502 back to horizontal. Accordingly, FIG. 5D shows the angle of the user's head 502 following the selection of each of the numbers in the PIN, as shown by FIG. 4D.

Note that while the illustrated unlock sequence entered contains a sequence of four numbers selected from four rows of numbers, the length of the unlock sequence and the number of rows displayed to the user may vary, depending upon the particular implementation.

### IV. Additional Aspects

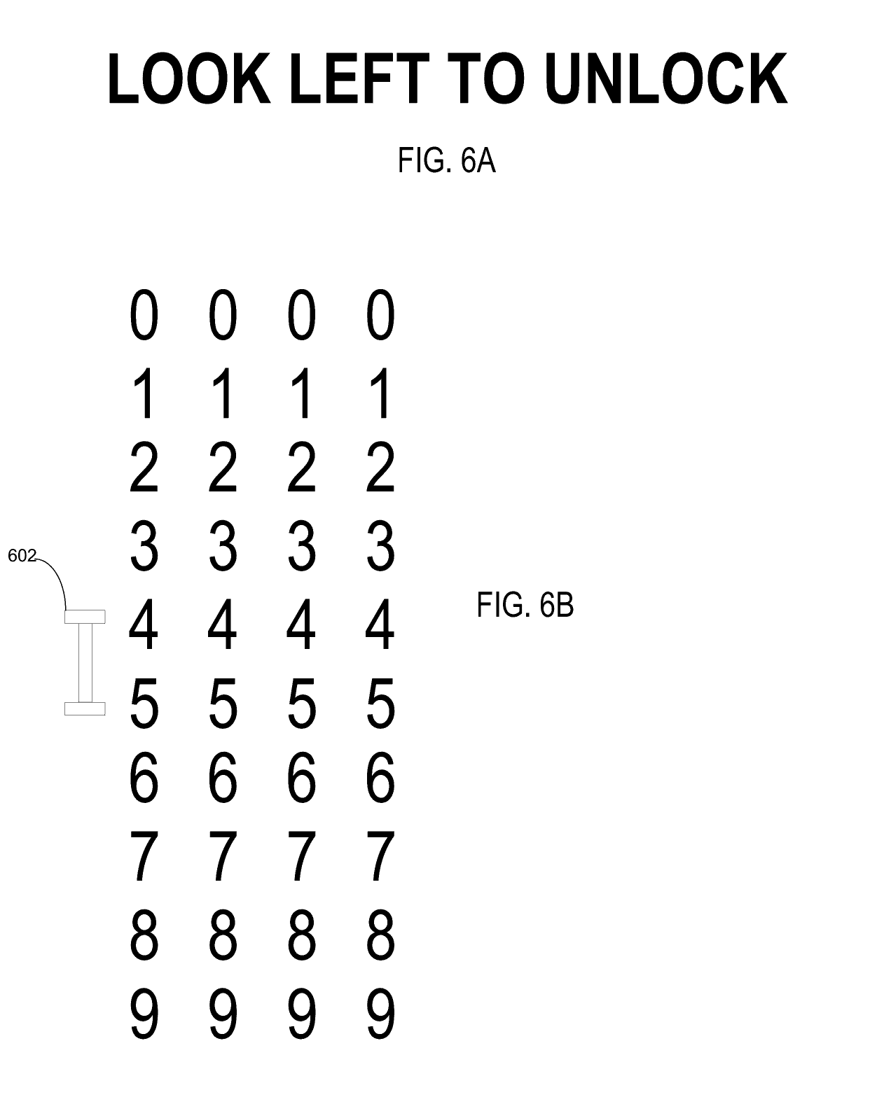

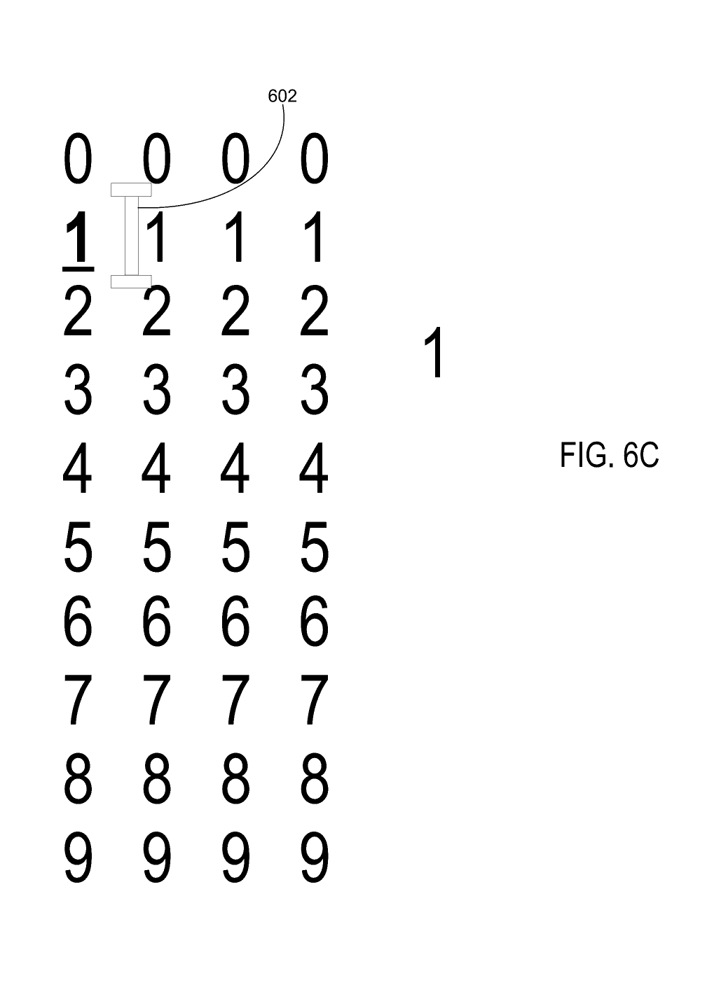

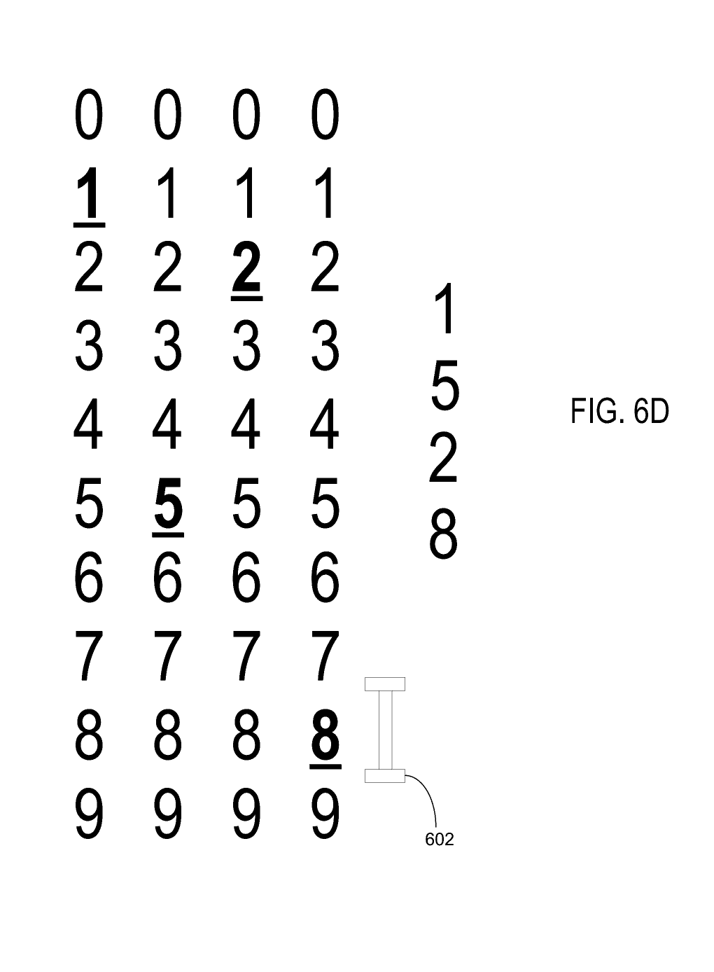

In additional embodiments, the display may require the user to select numbers for the PIN by moving his head in a different direction than up-to-down. For example, the user may be required to look down to initiate the unlock sequence and may then be required to navigate up through the rows of numbers to select the PIN. Alternatively, the rows of numbers may be presented vertically to the user. Then, the user may be required to look to the left to initiate the unlock procedure and then move his head to the right to traverse the vertical rows (columns) of numbers and select the PIN. FIGS. 6A to 6D illustrate an example sequence of screenshots of an HMD's display when the rows are presented vertically, as a user enters an unlock sequence.

The HMD may initially display a message to the user, indicating that the user may look left in order to initiate the unlock procedure, as shown in FIG. 6A. As shown in FIG. 6B, columns of numbers may then be displayed to the user. When the HMD displays the columns of numbers, the HMD may initially display a graphic representation of an input region 602 to the left of the columns of numbers. The HMD may then move the input region 602 with respect to the columns of numbers based on the wearer's head movements.

As the HMD detects head movement, the HMD may move the columns of numbers with respect to the display, while keeping the input region 602 centered in the display. In particular, the HMD may detect head movement upward and responsively move the columns of numbers down in the display. Further, the HMD may detect head movement to the right and responsively move the columns of numbers to the left in the display. Accordingly, the position of the input region relative to the columns of numbers may be controlled by user head movements, as shown by the change in position of the input region relative to the columns of numbers between the screenshot in FIG. 6B and the screenshot in FIG. 6C. Thus, by causing the input region 602 to cross the right of the first column of numbers through the “1,” as shown in the screenshot in FIG. 6C, the user has selected “1” as the first number in the unlock sequence.

The HMD may then detect additional head movements up and down as the user navigates the input region 602 vertically across the numbers within a given column of numbers. In particular, the HMD may detect head movement upward and responsively move the columns of numbers down in the display. Further, the HMD may detect head movement downward and responsively move the columns of numbers up in the display. In an example embodiment, the input region 602 may be prevented from moving past the last number on the top and bottom of each of the columns of numbers.

Additionally, the HMD may detect further head movement to the right and responsively move the columns of numbers to the left in the display. Numbers may be selected from the columns of numbers based on where the input region 602 crosses each column of numbers. FIG. 6D shows a screenshot of the display after the user has selected the unlock sequence “1528” by causing the input region 602 to cross through the “1” in the first column of numbers, the “5” in the second column of numbers, the “2” in the third column of numbers, and the “8” in the last column of numbers. At this point, the HMD may verify that the unlock sequence has been entered correctly, and responsively unlock.

In another embodiment, the rows of numbers may be presented to the user vertically as columns, but the user may be required to navigate right-to-left. Accordingly, the user may be required to look to the right past a certain angle to initiate the unlock procedure. Columns may then be displayed to the user so that the user may navigate to the left through the columns in order to select the PIN numbers.

In further embodiments, the rows may be presented to the user as curved arcs (e.g., arcs of a circle) rather than straight lines. Head movements in a direction along one of the arcs may determine the location of the input region within a row. Further, head movements in a direction across the arcs may determine which row contains the input region. Different degrees of curvature may be used for the arcs. Additionally, the arcs may be arranged vertically, horizontally, or along a different direction. In some examples, traversing the numbers in an arc may require less head movement than traversing numbers in a straight row.

In additional embodiments, the user may be able to use a touch-based interface, such as a touchpad or touchscreen, to navigate through the rows of numbers to select a PIN. For instance, an HMD such as HMD 172 of FIG. 1D, may detect finger movements on a side-mounted touchpad 182. The user may be able to move the cursor through the rows of numbers by moving his fingers over the touchpad. The touchpad may be used in addition to and/or instead of head movements to select some or all of the numbers from the unlock sequence.

In a further aspect, the size and or shape of the input region may vary. Similarly, the graphical representation of the input region in a lock screen may vary. For instance, while FIGS. 4A to 4D and 6A to 6D show lock screens that include an icon shaped like a cursor for the input region, differently shaped and/or differently sized graphical icons may be utilized to visually represent the input region. Other variations to the input region and/or the visual representation of the input region are also possible.

In another aspect, the PIN could include other types of characters and/or symbols (e.g., letters, punctuation, and so on), in addition or in the alternative to numbers. For example, the PIN may be made up only of letters, in which case the rows of characters displayed to the user may only contain letters. In an alternative embodiment, the PIN may be made up of a combination of letters and numbers, in which case the rows of characters displayed to the user may contain both letters and numbers. Other combinations are also possible.

In an additional aspect, each row of characters may contain the same set of characters. Alternatively, each row of characters may contain a subset of the set of characters. For example, perhaps only four numbers selected from the set of ten single-digit numbers are displayed in each row. Each row could then contain the number needed for the PIN and three additional random numbers selected from the full set, for example.

Further, the rows of characters may be displayed in a sequential order or in some other order. For example, the order of each row of characters could be randomized. Alternatively, the order of the characters in each row may be sequential but the first character in the row (and thus the starting point of the sequence) could be randomized. Other methods of ordering the characters in the rows are also possible. These different methods could be an optional feature, providing the user with the option of possibly having improved security at a cost of increased time to unlock the device.

In further embodiments, when an attempt to input an unlock sequence is determined to have failed (e.g., when an input sequence does not match the predetermined unlock sequence), a computing device may reset the lock screen and allow one or more additional attempts to input the unlock sequence. Further, a computing device may implement a process that provides additional security in the event of multiple unsuccessful attempts to input the unlock sequence. For example, after a certain number of unsuccessful attempts, the computing device may responsively disable the lock-screen for a certain period of time (referred to herein as a “lockout period”), such that the user cannot unlock the device.

Further, if additional unsuccessful attempts are made after the lockout period ends, the computing device may increase the duration of a subsequent lockout period. As a specific example, a computing device could lock a user out for one minute after five unsuccessful attempts, for an hour after five more unsuccessful attempts (e.g., ten unsuccessful attempts in total), for a day after five more unsuccessful attempts (e.g., fifteen unsuccessful attempts in total), and so on. Other examples are also possible.

In another aspect, a computing device may provide audio feedback indicating when the user has correctly inputted each number in an unlock sequence. Additionally or alternatively, a computing device may provide audio feedback indicating when the user has correctly provided the entire sequence making up the unlock sequence and/or indicating when the user has made an error.

### V. Conclusion

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method comprising:
while a computing device is locked, causing a display of the computing device to display two or more rows of characters and an input region that is moveable over the rows of characters, wherein the rows are ordered from a first row to a last row;
based on head-movement data that is indicative of head movement, determining one or more movements of the input region with respect to the rows of characters;
based on the one or more movements of the input region, determining when the input region crosses in a direction from the first row to the last row through a respective character in each row of the two or more rows;
in response to determining when the input region crosses in the direction from the first row to the last row through the respective character in each row of the two or more rows, selecting the respective character in each row of the two or more rows that was crossed in the direction from the first row to the last row by the input region;
determining an input sequence that comprises the selected respective character from each row of the two or more rows in an ordering from the first row to the last row;
determining whether or not the input sequence matches a predetermined unlock sequence, wherein the predetermined unlock sequence comprises a predetermined sequence of two or more characters; and
based on the determination as to whether or not the input sequence matches the predetermined unlock sequence, determining whether or not to unlock the computing device.

2. The method of claim 1, wherein each character in the unlock sequence is selected from a same set of characters.

3. The method of claim 1, wherein each of the two or more rows of characters contains the same set of characters.

4. The method of claim 1, wherein the characters in each of the two or more rows of characters are displayed in a random order.

5. The method of claim 1, wherein each of the two or more rows of characters contains a subset of a first set of characters.

6. The method of claim 1, further comprising receiving gesture data corresponding to one or more gestures, wherein:
the gesture data is received during the one or more movements of the input region with respect to the rows of characters; and
the respective character in each row of the two or more rows is selected based on a location of the input region in each row of the two or more rows at or near a time of a corresponding one of the gestures.

7. The method of claim 1, further comprising causing the display of the computing device to display one or more additional rows of characters beyond the two or more rows of characters in the direction from the first row to the last row.

8. The method of claim 1, further comprising causing the display of the computing device to display a graphic indication at each of the selected characters in the input sequence.

9. The method of claim 1, wherein each character in the two or more rows of characters is a single-digit number.

10. The method of claim 1, wherein four rows of characters are displayed.

11. The method of claim 1, wherein:
the two or more rows of characters are displayed after receiving head-movement data that is indicative of upward head movement;
the location of the input region relative to the two or more rows of characters is determined based on head-movement data that is indicative of vertical head movement; and
the location of the input region relative to the characters within a row of characters is determined based on head-movement data that is indicative of horizontal head movement.

12. The method of claim 1, wherein determining when the input region crosses in the direction from the first row to the last row through a respective character in each row of the two or more rows comprises:
determining when the input region crosses in the direction from the first row to the last row through the bottom of the respective character in each row of the two or more rows.

13. The method of claim 1, further comprising unselecting a previously selected character when the input region crosses the top of the row of characters containing the previously selected character.

14. The method of claim 1, wherein:
the two or more rows of characters are displayed after receiving head-movement data that is indicative of downward head movement;
the location of the input region relative to the two or more rows of characters is determined based on head-movement data that is indicative of vertical head movement; and
the location of the input region relative to the characters within a row of characters is determined based on head-movement data that is indicative of horizontal head movement.

15. The method of claim 1, wherein:
the two or more rows of characters are displayed vertically after receiving head-movement data that is indicative of leftward head movement;
the location of the input region relative to the two or more rows of characters is determined based on head-movement data that is indicative of horizontal head movement; and
the location of the input region relative to the characters within a row of characters is determined based on head-movement data that is indicative of vertical head movement.

16. The method of claim 1, wherein:
the two or more rows of characters are displayed vertically after receiving head-movement data that is indicative of rightward head movement;
the location of the input region relative to the two or more rows of characters is determined based on head-movement data that is indicative of horizontal head movement; and
the location of the input region relative to the characters within a row of characters is determined based on head-movement data that is indicative of vertical head movement.

17. The method of claim 1, wherein:
the two or more rows of characters are displayed as two or more curved arcs;
the location of the input region relative to the two or more rows of characters is determined based on head-movement data that is indicative of head movement across the curved arcs; and
the location of the input region relative to the characters within a row of characters is determined based on head-movement data that is indicative of head movement along one of the curved arcs.

18. A non-transitory computer readable medium having stored therein instructions that, when executed by a computing device, cause the computing device to perform functions comprising:
while the computing device is locked, displaying two or more rows of characters and an input region that is moveable over the rows of characters, wherein the rows are ordered from a first row to a last row;
receiving head-movement data that is indicative of head movement;
based on the head-movement data, determining one or more movements of the input region with respect to the rows of characters;
based on the one or more movements of the input region, determining when the input region crosses in a direction from the first row to the last row through a respective character in each row of the two or more rows;
in response to determining when the input region crosses in the direction from the first row to the last row through the respective character in each row of the two or more rows, selecting the respective character in each row of the two or more rows that was crossed in the direction from the first row to the last row by the input region;
determining an input sequence that comprises the selected respective character from each row of the two or more rows in an ordering from the first row to the last row;
determining whether or not the input sequence matches a predetermined unlock sequence, wherein the predetermined unlock sequence comprises a predetermined sequence of two or more characters;
when the input sequence matches the predetermined unlock sequence, causing the computing device to unlock; and
when the input sequence does not match the predetermined unlock sequence, refraining from unlocking the computing device.

19. (canceled)

20. The non-transitory computer readable medium of claim 18, wherein each of the two or more rows of characters contains a same set of characters.

21. The non-transitory computer readable medium of claim 18, wherein the characters in each of the two or more rows of characters are displayed in a random order.

22. The non-transitory computer readable medium of claim 18, wherein:
the two or more rows of characters are displayed by the computing device after receiving head-movement data that is indicative of upward head movement;
the location of the input region relative to the two or more rows of characters is determined based on head-movement data that is indicative of vertical head movement; and
the location of the input region relative to the characters within a row of characters is determined based on head-movement data that is indicative of horizontal head movement.

23. A computing device comprising:
a display;
a non-transitory computer readable medium; and
program instructions stored on the non-transitory computer readable medium and executable by at least one processor to:
while the computing device is locked, cause the display to display two or more rows of characters and an input region that is moveable over the rows of characters, wherein the rows are ordered from a first row to a last row;
receive head-movement data that is indicative of head movement;
based on head-movement data, determine one or more movements of the input region with respect to the rows of characters;
based on the one or more movements of the input region, determine when the input region crosses in a direction from the first row to the last row through a respective character in each row of the two or more rows;
in response to determining when the input region crosses in the direction from the first row to the last row through the respective character in each row of the two or more rows, select the respective character in each row of the two or more rows that was crossed in the direction from the first row to the last row by the input region;
determine an input sequence that comprises the selected respective character from each row of the two or more rows in an ordering from the first row to the last row;
determine whether or not the input sequence matches a predetermined unlock sequence, wherein the predetermined unlock sequence comprises a predetermined sequence of two or more characters; and
based on the determination as to whether or not the input sequence matches the predetermined unlock sequence, determine whether or not to unlock the computing device.

24. The computing device of claim 23, wherein the device is implemented in or takes the form of a head-mountable device (HMD).

25. The computing device of claim 23, further comprising a touch-based interface, wherein the one or more movements of the input region with respect to the rows of characters are determined based on input data from the touch-based interface.

26. (canceled)

27. (canceled)

28. (canceled)

29. The computing device of claim 23, wherein:
the two or more rows of characters are displayed by the computing device after receiving head-movement data that is indicative of upward head movement;
the location of the input region relative to the two or more rows of characters is determined based on head-movement data that is indicative of vertical head movement; and
the location of the input region relative to the characters within a row of characters is determined based on head-movement data that is indicative of horizontal head movement.

30. The method of claim 1, wherein a total number of displayed rows is greater than a number of characters in the predetermined unlock sequence, the method further comprising:
receiving an input signal indicating that the input sequence has been fully entered; and
in response to receiving the input signal indicating that the input sequence has been fully entered, determining whether or not the input sequence matches the predetermined unlock sequence.

31. The method of claim 1, wherein the one or more movements of the input region are proportional to the head movement.

32. The method of claim 1, wherein the input region is locked into a single row of the two or more rows, wherein determining the one or more movements of the input region with respect to the two or more rows comprises:
determining, based on the head-movement data, an angle of the head movement; and
when the angle of the head movement is greater than a threshold angle, moving the input region from one row of the two or more rows to a next row of the two or more rows.

33. The method of claim 1, further comprising unselecting a previously selected character when the input region crosses in a reverse direction, from the last row to the first row, through the previously selected character.
